(19) United States
(12) Patent Application Publication
(10) Pub. No.: US 2026/0285254 A1
(43) Pub. Date: Sep. 24, 2026

(54) INFORMATION PROCESSING METHOD, INFORMATION PROCESSING APPARATUS, AND NON-TRANSITORY COMPUTER READABLE MEDIUM

(71) Applicant: TOYOTA JIDOSHA KABUSHIKI KAISHA, Toyota-shi Aichi-ken (JP)

(72) Inventor: Keizoh KAWAGUCHI, Toyota-shi Aichi-ken (JP)

(73) Assignee: TOYOTA JIDOSHA KABUSHIKI KAISHA, Toyota-shi Aichi-ken (JP)

(21) Appl. No.: 19/568,132

(22) Filed: Mar. 16, 2026

(30) Foreign Application Priority Data
Mar. 24, 2025 (JP) 2025-048730

(51) Int. Cl. B60R 25/24; B60R 25/25; B60R 25/34; G06V 40/16

(52) U.S. Cl. CPC B60R 25/24; B60R 25/25; B60R 25/34; G06V 40/172

(57) ABSTRACT

In a vehicle associated with a plurality of users, an information processing apparatus sets a group for each of the plurality of users. The information processing apparatus identifies a first user who drives the vehicle from among the plurality of users, and sets the first user as a driver. Next, the information processing apparatus identifies a first group set for the first user. Then, while the first user is set as the driver, the information processing apparatus allows only the first user and a second user who belongs to the first group to access predetermined information regarding the vehicle, and presents the predetermined information only to the first user and the second user.

### CROSS-REFERENCE TO RELATED APPLICATION

This application claims priority to Japanese Patent Application No. 2025-048730, filed on Mar. 24, 2025, the entire contents of which are incorporated herein by reference.

### TECHNICAL FIELD

The present disclosure relates to an information processing method, an information processing apparatus, and a non-transitory computer readable medium.

### BACKGROUND

Technology for presenting specific information regarding vehicles to users are known. For example, Patent Literature (PTL) 1 discloses technology in which when a vehicle associated with a plurality of users is parked, information regarding the vehicle's parking position is transmitted to a terminal of a first user, while the information regarding the vehicle's parking position is not transmitted to a terminal of a second user who is not the first user.

### CITATION LIST

### Patent Literature

PTL 1: JP 2024-046260 A

### SUMMARY

There is room for improvement in determining a user to whom predetermined information is presented.

It would be helpful to improve the determination of users associated with a vehicle, to whom predetermined information is presented.

An information processing method according to an embodiment of the present disclosure is performed by an information processing apparatus, the information processing method including:
in a vehicle associated with a plurality of users, setting a group for each of the plurality of users;
identifying a first user who drives the vehicle from among the plurality of users by detecting the use of a smart key or a digital key linked to the first user or by facial recognition, and setting the first user as a driver;
identifying a first group set for the first user; and
while the first user is set as the driver, allowing only the first user and a second user who belongs to the first group to access predetermined information regarding the vehicle, and presenting the predetermined information only to the first user and the second user.

An information processing method according to an embodiment of the present disclosure is performed by an information processing apparatus, the information processing method including:
in a vehicle associated with a plurality of users, setting a group for each of the plurality of users;
identifying a first user who drives the vehicle from among the plurality of users, and setting the first user as a driver;
identifying a first group set for the first user; and
while the first user is set as the driver, allowing only the first user and a second user who belongs to the first group to access predetermined information regarding the vehicle, and presenting the predetermined information only to the first user and the second user.

An information processing apparatus according to an embodiment of the present disclosure includes a controller configured to:
in a vehicle associated with a plurality of users, set a group for each of the plurality of users;
identify a first user who drives the vehicle from among the plurality of users by detecting the use of a smart key or a digital key linked to the first user or by facial recognition, and set the first user as a driver;
identify a first group set for the first user; and
while the first user is set as the driver, allow only the first user and a second user who belongs to the first group to access predetermined information regarding the vehicle, and present the predetermined information only to the first user and the second user.

A non-transitory computer readable medium according to an embodiment of the present disclosure stores a program configured to cause an information processing apparatus to execute operations, the operations including:
in a vehicle associated with a plurality of users, setting a group for each of the plurality of users;
identifying a first user who drives the vehicle from among the plurality of users by detecting the use of a smart key or a digital key linked to the first user or by facial recognition, and setting the first user as a driver;
identifying a first group set for the first user; and
while the first user is set as the driver, allowing only the first user and a second user who belongs to the first group to access predetermined information regarding the vehicle, and presenting the predetermined information only to the first user and the second user.

A non-transitory computer readable medium according to an embodiment of the present disclosure stores a program configured to cause an information processing apparatus to execute operations, the operations including:
in a vehicle associated with a plurality of users, setting a group for each of the plurality of users;
identifying a first user who drives the vehicle from among the plurality of users, and setting the first user as a driver;
identifying a first group set for the first user; and
while the first user is set as the driver, allowing only the first user and a second user who belongs to the first group to access predetermined information regarding the vehicle, and presenting the predetermined information only to the first user and the second user.

According to an embodiment of the present disclosure, it becomes possible to improve the determination of users associated with a vehicle, to whom predetermined information is presented.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of an information processing apparatus; and

FIG. 3 is a flowchart illustrating operations of the information processing apparatus.

### DETAILED DESCRIPTION

Hereinafter, an embodiment of the present disclosure will be described.

### Outline of Embodiment

An outline of a system 1 according to an embodiment of the present disclosure will be described with reference to FIG. 1. The system 1 includes an information processing apparatus 10 and a terminal apparatus 20. The information processing apparatus 10 and the terminal apparatus 20 are communicably connected to a network 30 including, for example, the Internet, a mobile communication network, and the like.

The information processing apparatus 10 is, for example, an in-vehicle apparatus installed in a vehicle, or a server that provides instructions to a vehicle via the network 30. The information processing apparatus 10 can communicate with the terminal apparatus 20 via the network 30. The vehicle is any vehicle such as an automobile or a motorcycle, for example.

The terminal apparatus 20 is a computer, such as a personal computer (PC), a smartphone, or a tablet terminal, for example. The terminal apparatus 20 is a computer used by each of a plurality of users associated with the vehicle, for example.

An outline of the present embodiment will be first described, and details thereof will be described later. In the vehicle associated with a plurality of users, the information processing apparatus 10 sets a group for each of the plurality of users. The information processing apparatus 10 identifies a first user who drives the vehicle from among the plurality of users, and sets the first user as a driver. Next, the information processing apparatus 10 identifies a first group set for the first user. Then, while the first user is set as the driver, the information processing apparatus 10 allows only the first user and a second user who belongs to the first group to access predetermined information regarding the vehicle, and presents the predetermined information only to the first user and the second user.

The phrase “vehicle associated with the plurality of users” refers to a vehicle in which information on a plurality of users, e.g., not only one driver who drives the vehicle but also other drivers who drive the vehicle and passengers in the vehicle is stored in the information processing apparatus 10. The term “predetermined information” refers to any vehicle information generated, collected, or acquired during driver settings, such as the vehicle's location information, the driver's driving history information, information regarding the vehicle's door lock, information regarding the vehicle's window closing, or information on objects placed in the vehicle, for example. The vehicle associated with the plurality of users is capable of providing the vehicle's location information and the like to the plurality of users. However, in a case in which a parent, a child, and a friend of each of the parent and child are associated with the vehicle as a plurality of users, for example, the vehicle's location information and the like can be referenced by the parent even when the child is a driver and only the child's friend is a passenger. In this case, according to the present embodiment, by registering only the child's friend as a user of a group for the child as a driver, it is possible to prevent the parent from referencing the vehicle's location information when the child is a driver and only the child's friend is a passenger. Therefore, according to the present embodiment, the predetermined information regarding the vehicle can be presented only to the necessary users, thus improving the determination of users associated with the vehicle, to whom the predetermined information is presented.

Next, configurations of the system 1 will be described in detail.

### Configuration of Information Processing Apparatus

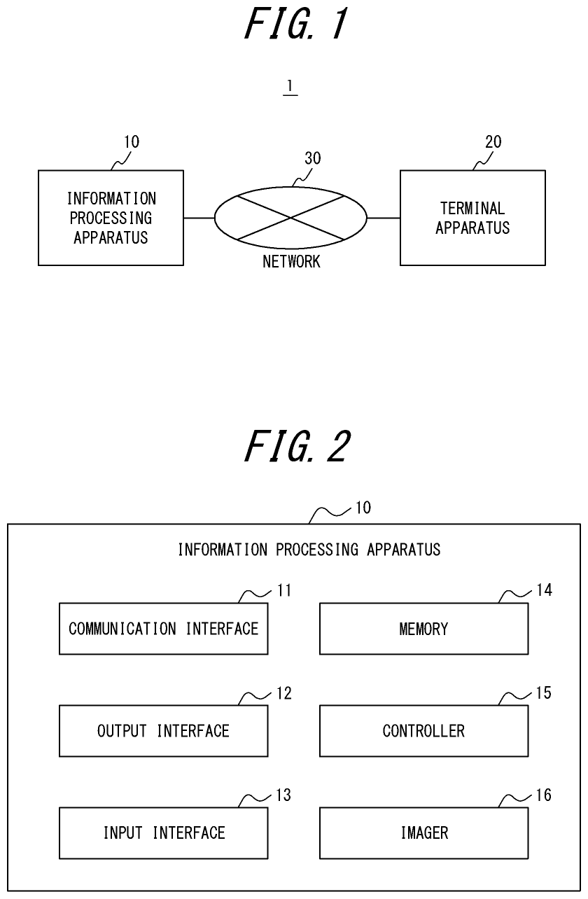

As illustrated in FIG. 2, the information processing apparatus 10 includes a communication interface 11, an output interface 12, an input interface 13, a memory 14, a controller 15, and an imager 16. The information processing apparatus 10 may be constituted of an in-vehicle apparatus and a server that provides instructions to a vehicle. For example, the output interface 12, the input interface 13, and the imager 16 of the information processing apparatus 10 may be provided in the in-vehicle apparatus, and the memory 14 and the controller 15 may be provided in the server.

The communication interface 11 includes at least one communication interface for connecting to the network 30. The communication interface is compliant with, for example, but not limited to, a mobile communication standard, a wired local area network (LAN) standard, or a wireless LAN standard, and may be compliant with any appropriate communication standard. In the present embodiment, the information processing apparatus 10 communicates with the terminal apparatus 20 via the communication interface 11 and the network 30.

The output interface 12 includes at least one output device that is installed in the vehicle to output information. The output device is, for example, a display for outputting information as video, a speaker for outputting information as audio, or the like, but is not limited to these. Alternatively, the output interface 12 may include an interface for connecting to an external output device.

The input interface 13 includes at least one input device that is installed in the vehicle to detect input operations by users. The input device is, for example, a physical key, a capacitive key, a mouse, a touch panel, a touch screen integrally provided with a display of the output interface 12, a microphone, or the like, but is not limited to these. Alternatively, the input interface 13 may include an interface for connecting to an external input device. In the present embodiment, the input interface 13 may be used to acquire the users' voice that is necessary to acquire the vehicle information or user information.

The memory 14 includes one or more memories. The memories included in the memory 14 may each function as, for example, a main memory, an auxiliary memory, or a cache memory. The memory 14 stores any information to be used for operations of the information processing apparatus 10. For example, the memory 14 may store a system program, an application program, embedded software, and the like. The memory 14 stores user information, which is information on users associated with the vehicle, group information, which is information on groups to which the users belong, and predetermined information regarding the vehicle. The memory 14 may be provided in the in-vehicle apparatus or in the server. The in-vehicle apparatus and the server may constitute the entire memory 14.

The “user information” includes information that uniquely identifies each user, such as user IDs, personal information on each user such as names and ages, and information on a smart key or a digital key associated with each user, but is not limited to these. For example, the user information may include an image of each user and information on the group to which the user belongs.

The “group” is composed of one user set as a driver and other users set as passengers or the like. One user may belong to multiple groups. For example, User A may be set as a driver of Group A and Group B. For example, User B may be set as a passenger or the like of Group A and Group B. For example, User A may be set as a driver of Group A and as a passenger or the like of Group B.

The controller 15 includes at least one processor, at least one programmable circuit, at least one dedicated circuit, or a combination of these. The processor is, for example, a general purpose processor such as a central processing unit (CPU) or a graphics processing unit (GPU), or a dedicated processor that is dedicated to specific processing, but is not limited to these. The programmable circuit is a field-programmable gate array (FPGA), for example, but is not limited to this. The dedicated circuit is an application specific integrated circuit (ASIC), for example, but is not limited to this. The controller 15 controls operations of the vehicle equipped with the information processing apparatus 10 and the information processing apparatus 10 itself.

The imager 16 includes one or more cameras that are installed in the vehicle to enable imaging of the interior of the vehicle and persons therein. The imager 16 may be used for facial recognition to identify a driver of the vehicle.

### Operation Flow of Information Processing Apparatus

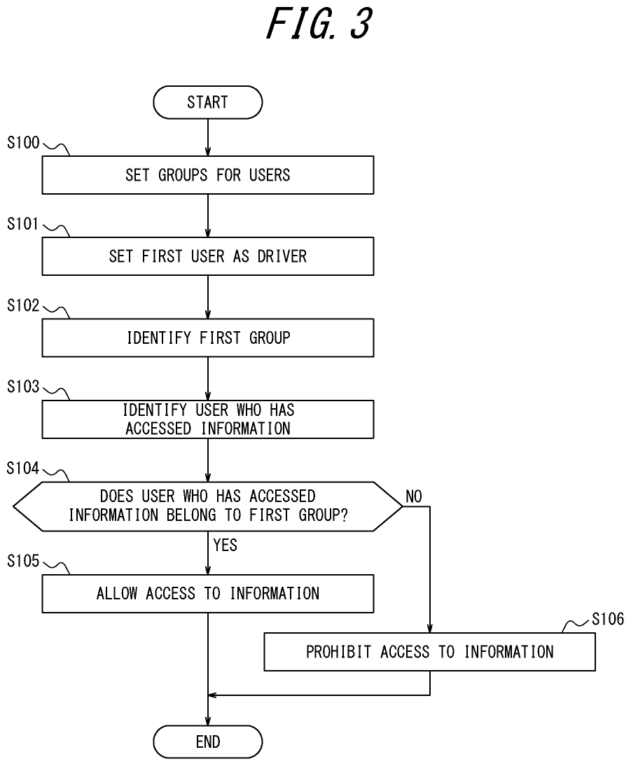

Operations of the information processing apparatus 10 according to the present embodiment will be described with reference to FIG. 3.

S100: The controller 15 of the information processing apparatus 10 sets a group for each of a plurality of users associated with the vehicle.

Specifically, a user who meets a specific condition designates a group for each of a plurality of users using the input interface 13, so the controller 15 sets a group for each of the plurality of users. The designation of the group may also be performed by the terminal apparatus 20. The specific condition may be, for example, a user who can register users associated with the vehicle, such as the owner of the vehicle. The specific condition may be a user set as a driver in each group. In this case, the controller 15 may allow each user who is set as a driver in each group to make the setting of only the group set as the driver for each of the plurality of users.

S101: The controller 15 identifies a first user who drives the vehicle from among the plurality of users, and sets the first user as a driver.

Specifically, upon detecting the use of a smart key or digital key, the controller 15 identifies, from user information in the memory 14, a user linked to the used smart key or digital key as a first user. Then, the controller 15 sets the first user as a driver. The controller 15 may identify a first user by facial recognition using an image of a person sitting in the driver's seat captured by the imager 16 and user images included in the user information in the memory 14, and set the first user as a driver.

S102: The controller 15 identifies a first group set for the first user.

Specifically, the controller 15 identifies, as a first group, a group in which the first user is set as a driver from group information or user information on the first user in the memory 14. The controller 15 may display the group in which the first user is set as a driver on a display of the output interface 12, and allow the first user to confirm whether the identified group should be the first group. When there are multiple identified groups, the controller 15 may display the groups in which the first user is set as a driver on the display of the output interface 12 and allow the first user to select which group should be the first group.

S103: The controller 15 identifies a user who has accessed predetermined information.

Specifically, when any of the plurality of users has accessed predetermined information using the terminal apparatus 20, the controller 15 identifies the access user who has accessed the predetermined information, from an user ID included in an access request transmitted to the information processing apparatus 10.

S104: The controller 15 determines whether the access user is the first user or a second user who belongs to the first group.

Specifically, the controller 15 determines whether the access user is the first user or a second user who belongs to the first group, from group information on the first group or user information on the access user in the memory 14. When the access user is the first user or the second user (S104-Yes), the controller 15 proceeds to S105. When the access user is neither the first user nor the second user (S104-No), the controller 15 proceeds to S106.

When S101 is performed again before performing S103, the current driver setting for the first user is canceled, and S104 is performed by setting as a first user a different user who has newly set as a driver.

S105: The controller 15 allows the access user to access the predetermined information, and presents the predetermined information to the access user.

Specifically, the controller 15 transmits the predetermined information to the terminal apparatus 20 of the access user. The terminal apparatus 20 displays the predetermined information on a display of the terminal apparatus 20.

The predetermined information may be pre-set or may be settable by the owner of the vehicle. The setting of the predetermined information may be performed using the information processing apparatus 10 or using the terminal apparatus 20.

S106: The controller 15 prohibits access to the predetermined information regarding the vehicle performed by the access user.

Specifically, the controller 15 transmits, to the terminal apparatus 20 of the access user, a notification indicating that access to the predetermined information cannot be performed. The terminal apparatus 20 displays information indicating that access to the predetermined information cannot be performed, for example, by displaying “You do not have permission to access” on the display of the terminal apparatus 20.

As described above, in the vehicle associated with a plurality of users, the information processing apparatus 10 according to the present embodiment sets a group for each of the plurality of users. The information processing apparatus 10 identifies a first user who drives the vehicle from among the plurality of users, and sets the first user as a driver. Next, the information processing apparatus 10 identifies a first group set for the first user. Then, while the first user is set as the driver, the information processing apparatus 10 allows only the first user and a second user who belongs to the first group to access predetermined information regarding the vehicle, and presents the predetermined information only to the first user and the second user.

With such a configuration, the predetermined information regarding the vehicle can be presented only to the necessary users, thus improving the determination of users associated with the vehicle, to whom the predetermined information is presented.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or divided.

For example, an embodiment in which the configuration and operations of the information processing apparatus 10 in the above embodiment are distributed to multiple computers capable of communicating with each other can be implemented.

Furthermore, for example, in the above-mentioned embodiment, the controller 15 may release the driver setting for the first user not only when another user is set as a driver but also when a predetermined time, such as 2 minutes, has elapsed since the first user has finished driving the vehicle. Alternatively, the controller 15 may release the driver setting for the first user when all predetermined tasks after driving, such as door locking, window closing, and removal of objects, are completed.

In the above-mentioned embodiment, the predetermined information may differ from group to group. For example, the predetermined information for Group A may include the vehicle's location information, the driver's driving history information, and the information regarding the vehicle's door lock, while the predetermined information for Group B may include the vehicle's location information and the driver's driving history information. In this case, the predetermined information for each group may be settable by a user who has been set as a driver in each group. Moreover, the predetermined information may be settable for each of the first user and the second user within the group. For example, the predetermined information for the first user may be set to include the driver's driving history information, while the predetermined information for the second user may be set to exclude the driver's driving history information. In this case, the predetermined information set for the first user may be settable only by the first user, and the predetermined information set for the second user may be settable only by the second user. The setting of the predetermined information may be performed using the information processing apparatus 10 or using the terminal apparatus 20.

Furthermore, in the above-mentioned embodiment, the controller 15 may allow only the first user and the second user to use predetermined functions regarding the vehicle while the first user is set as a driver. The “predetermined functions” may include remote control functions performed using the terminal apparatus 20, such as door locking and in-vehicle air conditioning. The predetermined functions may be pre-set or may be settable by the owner of the vehicle. Additionally, the predetermined functions may differ from group to group. For example, the predetermined functions for Group A may include door locking and remote control functions, while the predetermined functions for Group B may include only remote control functions. In this case, the predetermined information for each group may be settable by a user who has been set as a driver in each group. Moreover, the predetermined functions may be settable for each of the first user and the second user within the group. For example, the predetermined functions for the first user may be set to include door locking and remote control functions, while the predetermined functions for the second user may be set to include only the remote control functions. In this case, the predetermined functions set for the first user may be settable only by the first user, and the predetermined functions set for the second user may be settable only by the second user. The setting of the predetermined functions may be performed using the information processing apparatus 10 or using the terminal apparatus 20.

Furthermore, for example, in the above-mentioned variation, the controller 15 may allow the second user to set the predetermined information and/or the predetermined functions for the first user when the first user meets a first condition and the second user meets a second condition. For example, when the first user is an elderly person and the second user is the first user's adult son or daughter, the second user is allowed to set the predetermined information and/or the predetermined functions for the first user.

For example, an embodiment in which a general purpose computer functions as the information processing apparatus 10 according to the above embodiment can also be implemented. Specifically, a program in which processes for realizing the functions of the information processing apparatus 10 according to the above embodiment are written may be stored in a memory of a general purpose computer, and the program may be read and executed by a processor. Accordingly, the present disclosure can also be implemented as a program executable by a processor, or a non-transitory computer readable medium storing the program.

Examples of some embodiments of the present disclosure are described below. However, it should be noted that the embodiments of the present disclosure are not limited to these examples.
[Appendix 1] An information processing method performed by an information processing apparatus, the information processing method comprising:
   in a vehicle associated with a plurality of users, setting a group for each of the plurality of users;
   identifying a first user who drives the vehicle from among the plurality of users by detecting use of a smart key or a digital key linked to the first user or by facial recognition, and setting the first user as a driver;
   identifying a first group set for the first user; and
   while the first user is set as the driver, allowing only the first user and a second user who belongs to the first group to access predetermined information regarding the vehicle, and presenting the predetermined information only to the first user and the second user.
[Appendix 2] An information processing method performed by an information processing apparatus, the information processing method comprising:
   in a vehicle associated with a plurality of users, setting a group for each of the plurality of users;
   identifying a first user who drives the vehicle from among the plurality of users, and setting the first user as a driver;
   identifying a first group set for the first user; and
   while the first user is set as the driver, allowing only the first user and a second user who belongs to the first group to access predetermined information regarding the vehicle, and presenting the predetermined information only to the first user and the second user.
[Appendix 3] The information processing method according to appendix 2, wherein the predetermined information includes the vehicle's location information, the first user's driving history information, and/or information regarding the vehicle's door lock.
[Appendix 4] The information processing method according to appendix 2 or 3, further comprising allowing only the first user and the second user to use a predetermined function regarding the vehicle while the first user is set as the driver.
[Appendix 5] The information processing method according to any one of appendices 2 to 4, further comprising releasing the setting of the driver for the first user when a predetermined time has elapsed since the first user has finished driving the vehicle.
[Appendix 6] The information processing method according to any one of appendices 2 to 4, wherein the predetermined information is settable for each of the first user and the second user.
[Appendix 7] The information processing method according to appendix 6, wherein
   the predetermined information set for the first user is settable only by the first user, and
   the predetermined information set for the second user is settable only by the second user.
[Appendix 8] The information processing method according to appendix 7, further comprising allowing the second user to set the predetermined information for the first user when the first user meets a first condition and the second user meets a second condition.
[Appendix 9] The information processing method according to any one of appendices 4 to 8, wherein the predetermined function is settable for each of the first user and the second user.
[Appendix 10] An information processing apparatus comprising a controller configured to:
   in a vehicle associated with a plurality of users, set a group for each of the plurality of users;
   identify a first user who drives the vehicle from among the plurality of users by detecting use of a smart key or a digital key linked to the first user or by facial recognition, and set the first user as a driver;
   identify a first group set for the first user; and
   while the first user is set as the driver, allow only the first user and a second user who belongs to the first group to access predetermined information regarding the vehicle, and present the predetermined information only to the first user and the second user.
[Appendix 11] An information processing apparatus comprising a controller configured to:
   in a vehicle associated with a plurality of users, set a group for each of the plurality of users;
   identify a first user who drives the vehicle from among the plurality of users, and set the first user as a driver;
   identify a first group set for the first user; and
   while the first user is set as the driver, allow only the first user and a second user who belongs to the first group to access predetermined information regarding the vehicle, and present the predetermined information only to the first user and the second user.
[Appendix 12] The information processing apparatus according to appendix 11, wherein the predetermined information includes the vehicle's location information, the first user's driving history information, and/or information regarding the vehicle's door lock.
[Appendix 13] The information processing apparatus according to appendix 11 or 12, wherein the controller is configured to allow only the first user and the second user to use a predetermined function regarding the vehicle while the first user is set as the driver.
[Appendix 14] The information processing apparatus according to any one of appendices 11 to 13, wherein the controller is configured to release the setting of the driver for the first user when a predetermined time has elapsed since the first user has finished driving the vehicle.
[Appendix 15] The information processing apparatus according to any one of appendices 11 to 14, wherein the predetermined information is settable for each of the first user and the second user.
[Appendix 16] The information processing apparatus according to appendix 15, wherein
   the predetermined information set for the first user is settable only by the first user, and
   the predetermined information set for the second user is settable only by the second user.
[Appendix 17] The information processing apparatus according to appendix 16, wherein the controller is configured to allow the second user to set the predetermined information for the first user when the first user meets a first condition and the second user meets a second condition.
[Appendix 18] The information processing apparatus according to any one of appendices 13 to 17, wherein the predetermined function is settable for each of the first user and the second user.
[Appendix 19] A program configured to cause an information processing apparatus to execute operations, the operations comprising:
   in a vehicle associated with a plurality of users, setting a group for each of the plurality of users;
   identifying a first user who drives the vehicle from among the plurality of users by detecting use of a smart key or a digital key linked to the first user or by facial recognition, and setting the first user as a driver;
   identifying a first group set for the first user; and
   while the first user is set as the driver, allowing only the first user and a second user who belongs to the first group to access predetermined information regarding the vehicle, and presenting the predetermined information only to the first user and the second user.
[Appendix 20] A program configured to cause an information processing apparatus to execute operations, the operations comprising:
   in a vehicle associated with a plurality of users, setting a group for each of the plurality of users;
   identifying a first user who drives the vehicle from among the plurality of users, and setting the first user as a driver;
   identifying a first group set for the first user; and
   while the first user is set as the driver, allowing only the first user and a second user who belongs to the first group to access predetermined information regarding the vehicle, and presenting the predetermined information only to the first user and the second user.

1. An information processing method performed by an information processing apparatus, the information processing method comprising:
in a vehicle associated with a plurality of users, setting a group for each of the plurality of users;
identifying a first user who drives the vehicle from among the plurality of users by detecting use of a smart key or a digital key linked to the first user or by facial recognition, and setting the first user as a driver;
identifying a first group set for the first user; and
while the first user is set as the driver, allowing only the first user and a second user who belongs to the first group to access predetermined information regarding the vehicle, and presenting the predetermined information only to the first user and the second user.

2. An information processing method performed by an information processing apparatus, the information processing method comprising:
in a vehicle associated with a plurality of users, setting a group for each of the plurality of users;
identifying a first user who drives the vehicle from among the plurality of users, and setting the first user as a driver;
identifying a first group set for the first user; and
while the first user is set as the driver, allowing only the first user and a second user who belongs to the first group to access predetermined information regarding the vehicle, and presenting the predetermined information only to the first user and the second user.

3. The information processing method according to claim 2, wherein the predetermined information includes the vehicle's location information, the first user's driving history information, and/or information regarding the vehicle's door lock.

4. The information processing method according to claim 2, further comprising allowing only the first user and the second user to use a predetermined function regarding the vehicle while the first user is set as the driver.

5. The information processing method according to claim 2, further comprising releasing the setting of the driver for the first user when a predetermined time has elapsed since the first user has finished driving the vehicle.

6. The information processing method according to claim 2, wherein the predetermined information is settable for each of the first user and the second user.

7. The information processing method according to claim 6, wherein
the predetermined information set for the first user is settable only by the first user, and
the predetermined information set for the second user is settable only by the second user.

8. The information processing method according to claim 7, further comprising allowing the second user to set the predetermined information for the first user when the first user meets a first condition and the second user meets a second condition.

9. The information processing method according to claim 4, wherein the predetermined function is settable for each of the first user and the second user.

10. An information processing apparatus comprising a controller configured to:
in a vehicle associated with a plurality of users, set a group for each of the plurality of users;
identify a first user who drives the vehicle from among the plurality of users, and set the first user as a driver;
identify a first group set for the first user; and
while the first user is set as the driver, allow only the first user and a second user who belongs to the first group to access predetermined information regarding the vehicle, and present the predetermined information only to the first user and the second user.

11. The information processing apparatus according to claim 10, wherein the controller is configured to identify the first user by detecting use of a smart key or a digital key linked to the first user, or by facial recognition.

12. The information processing apparatus according to claim 10, wherein the predetermined information includes the vehicle's location information, the first user's driving history information, and/or information regarding the vehicle's door lock.

13. The information processing apparatus according to claim 10, wherein the controller is configured to allow only the first user and the second user to use a predetermined function regarding the vehicle while the first user is set as the driver.

14. The information processing apparatus according to claim 10, wherein the controller is configured to release the setting of the driver for the first user when a predetermined time has elapsed since the first user has finished driving the vehicle.

15. The information processing apparatus according to claim 10, wherein the predetermined information is settable for each of the first user and the second user.

16. The information processing apparatus according to claim 15, wherein
the predetermined information set for the first user is settable only by the first user, and
the predetermined information set for the second user is settable only by the second user.

17. The information processing apparatus according to claim 16, wherein the controller is configured to allow the second user to set the predetermined information for the first user when the first user meets a first condition and the second user meets a second condition.

18. The information processing apparatus according to claim 13, wherein the predetermined function is settable for each of the first user and the second user.

19. A non-transitory computer readable medium storing a program configured to cause a computer to function as the information processing apparatus according to claim 10.
